(19) United States
(12) Patent Application Publication
(10) Pub. No.: US 2022/0242719 A1
(43) Pub. Date: Aug. 4, 2022

(54) BASE WITH MECHANISM FOR DISPENSING LIQUID FROM A STAND-UP TAP POUCH

(71) Applicant: Panagiotis BILIAS, Varzika Attikis (GR)

(72) Inventor: Panagiotis BILIAS, Varzika Attikis (GR)

(21) Appl. No.: 17/621,824

(22) PCT Filed: Jun. 23, 2020
(86) PCT No.: PCT/GR2020/000033

§ 371 Date: Dec. 22, 2021

(30) Foreign Application Priority Data
Jun. 24, 2019 (GR) 20190100277

(51) Int. Cl. B67D 3/00

(52) U.S. Cl. CPC B67D 3/0083; B67D 3/0067

(57) ABSTRACT

The invention relates to bases for positioning tap pouch with a mechanism for aiding the emptying, which consists of the bases and the mechanism that exerts pressure on the tap pouch.

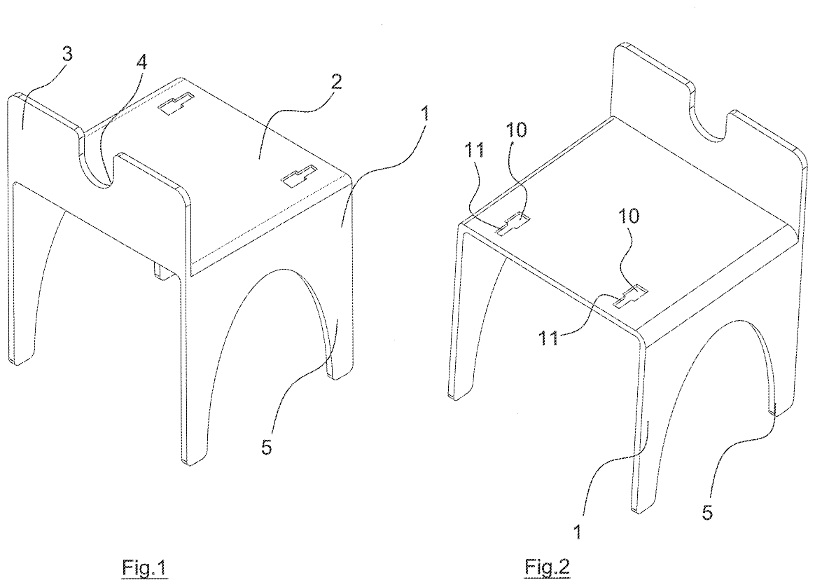

FIGS. 1 and 2 show in front view and rear view the base (1) in perspective. In these figures, a typical configuration of the base (1) is shown where the four legs (5) protrude, the front side (3), the port (4) through which the taps (7) protruding from the pouches (6) and (12), when these are placed on the surface (2), are passed. On the surface (2), the ports (10) and (11) are shown, in which the bases (15) of the mechanism (9) for aiding the emptying of the pouches (12) are mounted.

In FIG. 10, the components of the mechanism (9) for aiding the emptying are shown in exploded form as mentioned below. The cylindrical part (13), the arms (14). The arms (14) are mounted on the bases (15). The ends (27) are inserted in the gap (28). The rotation spring (18), after passing through the concentric holes (21) and (25) and the slots (22) and (26) operates as a shaft of the rotation points of the arms (14).

The present invention relates to bases for positioning tap pouches with mechanism that aids emptying, which consists of the base and a mechanism applying pressure on the tap pouch.

Bases for positioning tap pouches containing alcoholic beverages, juices, oil etc. have been unknown until now and the pouches are usually placed on shelves, cupboards, and tables. Thus, a proper use of the pouches and the convenience when using these is not ensured, while the emptying of the pouches is not complete and further effort by the user is required. An advantage of the use of the bases according to the present invention is that a wider use of the pouches is allowed and these can be used with further liquids. Also, the mechanism aiding the emptying of the individual pouches improves their function.

The proposed base may be used for individual pouches or pouches which are contained in paper housings and are used mainly for alcoholic beverages. By the present base, it is possible to use individual pouches in the kitchen for oil or vinegar as well as in banquets where each person serves himself by selecting the beverage he desires during meal serving. By the present invention, a wider use of the disposable individual pouches is made, thereby reducing the cost of the packages which until now are made of plastic, metal or glass. The use of the known packages has a negative impact for the environment due to the increased need for electricity consumption during production, while it is elegant and more functional. When the present base is used for pouches in paper housings, the mechanism that aids emptying cannot be used when the pouches are placed thereon or it is removed and placed for a subsequent use with a simple pouch again.

Hereinbelow, the production and operation of the base with reference to accompanying figures is described in detail, so that a person skilled in the art can appreciate the invention and its use:

FIG. 1 shows in perspective view the front side of a table-top base.

FIG. 2 shows in perspective view the rear side of a table-top base.

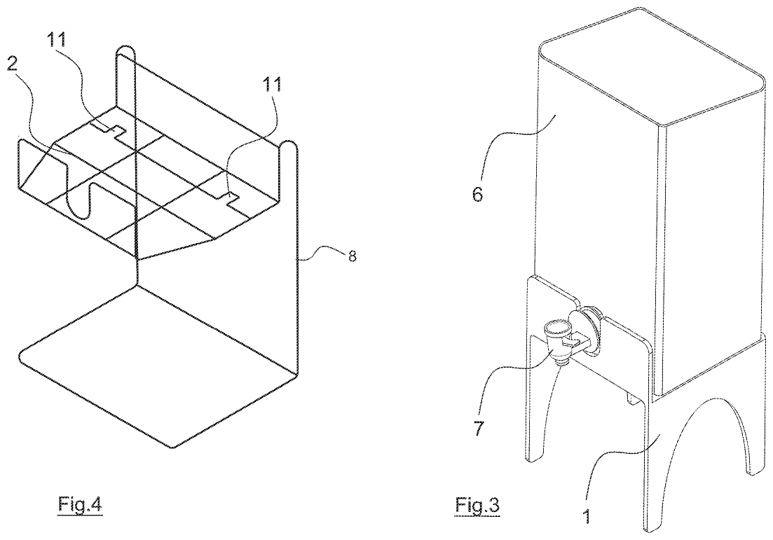

FIG. 3 shows in perspective view a table-top base with a pouch in a paper housing positioned thereon.

FIG. 4 shows in perspective view a table-top base made of a wire mesh.

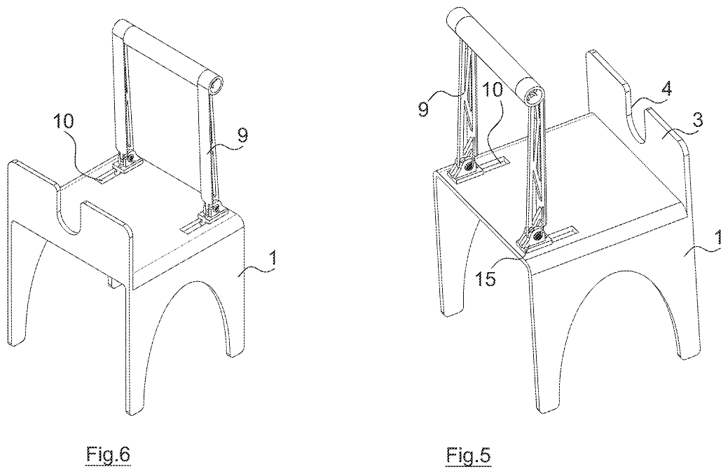

FIG. 5 shows in perspective view the rear side of the table-top base with a mounted mechanism for aiding emptying.

FIG. 6 shows in perspective view the front side of the table-top base with a mounted mechanism for aiding emptying.

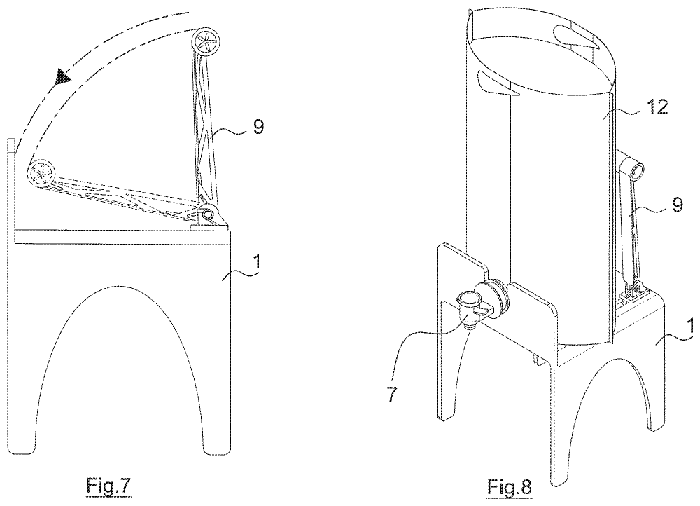

FIG. 7 shows in side view a table-top base with a mounted mechanism for aiding emptying in upright position.

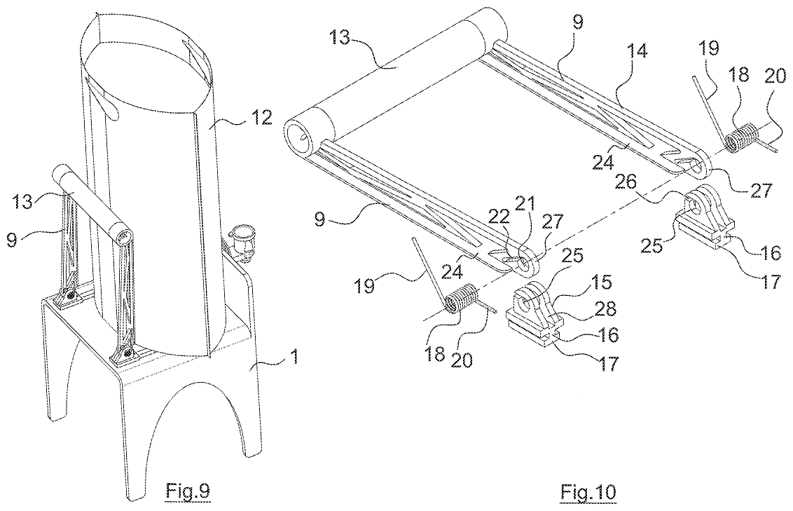

FIG. 8 shows the front view of a table-top base in perspective view having a pouch and a mounted aiding mechanism.

FIG. 9 shows the rear view of a table-top base in perspective view having a pouch and a mounted aiding mechanism.

FIG. 10 shows in perspective view the components constituting the mechanism for aiding emptying in exploded form.

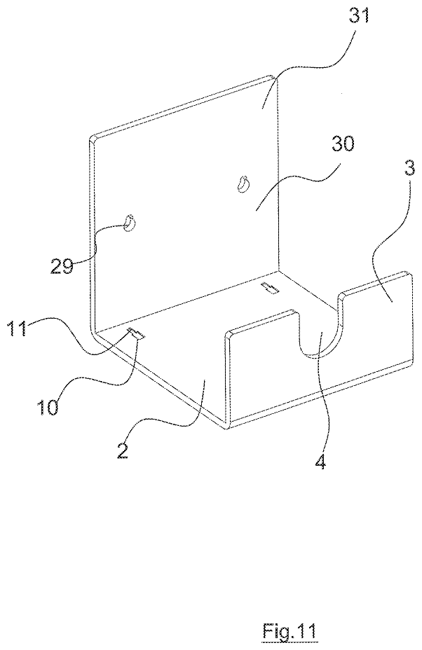

FIG. 11 shows in perspective view a base for pouches which may be table-top or suspendable on a vertical surface.

FIGS. 1 and 2 show the front and rear view of the base (1) in perspective view. In these figures, a typical configuration of the base (1) is shown, where the four legs (5) protrude, a front side (3), the port (4) through which the taps (7) protruding from the pouches (6) and (12), when these are one the surface (2), are passed. On the surface (2), the ports (10) and (11) are apparent, on which the bases (15) of the mechanism (9) for aiding the emptying of the pouches (12) are mounted. FIG. 3 shows the base (1) on which the pouch (6) in a paper housing rests, where the emptying tap (7) protrudes. FIG. 4 shows the base (8) according to the present invention which is manufactured as a wire mesh and the ports (11) through which the bases (15) of the mechanism for aiding the emptying of the pouches (12) pass, and the port (4) through which the taps (7) protruding from the pouches (6) and (12) when these are placed on the surface (2) pass. FIG. 5 shows in perspective view, the rear side of the base (1) having the mechanism (9) mounted in upright position. The bases (15) of the mechanism (9) are mounted in the ports (10) and (11). FIG. 7 shows in side view the base (1) with the mechanism (9) mounted in upright position. FIG. 7 shows in side view the base (1) with the mechanism for aiding the emptying of the pouches (12) mounted in upright position and inclined position, showing the motion path of the part (13) when it presses the pouches (12).

FIG. 8 shows the front side of the base (1) in perspective view with the positioned pouch (12) and the mounted mechanism (9) for aiding the emptying of the pouches (12). FIG. 9 shows the rear view of the base (1) in perspective view having the positioned pouch (12) and having the mechanism (9) for aiding the emptying of the pouches (12) mounted. FIG. 10 shows in perspective view the components constituting the mechanism (9) for aiding the emptying in exploded form and arranged as mentioned hereinbelow. The cylindrical part (13) connecting the arms (14). The arms (14) are mounted on the bases (15). The ends (27) are inserted in the gap (28). The rotation spring (18) after passing through the concentric holes (21) and (25) and the slots (22) and (26) operates as a shaft of the rotation points of the arms (14). The end (20) of the spring (18) contacts on the protruding part of the base (15) as the end (19) rotates so that it exerts pressure on the feet (23) and (24) of the arms (14) and forces them to rotate exerting pressure on the side of the pouches. The base (15) is configured in H-shape, with the upper and lower feet (17) being connected between them by the part (16). The bases (15), when the mechanism (9) is assembled, are guided through the ports (10) and pulled in the ports (11) where they are trapped, thereby stabilizing the mechanism. In order to position the pouches (12), the arms (9) are retracted with the one hand and with the other the pouch is positioned in the bases (1) or (8) and the cylindrical part (13) is allowed to touch the pouch. The force of the rotation springs (18), since they are under tension, is transferred on the arms (9). The arms (9) convey the forces of the springs by exerting pressure on the pouch, the pressure is higher when the pouch is full and is reduced as the level of the liquid falls, so that the flow of the liquid during emptying is continuous, stable and complete.

FIG. 11 shows in perspective view the base (30) for the pouches which can be positioned on a table or cupboard or suspended on a wall and on any vertical surface. On the side (31) of the base (30), holes (29) are provided for suspension screws or nails. Through the holes (10) and (11) the support bases of the mechanism (9) for aiding the emptying of the pouches (12) are passed.

The manufacturing materials of the bases (1) and (8) and (30) and of the mechanisms (9) may vary and there is no limitation for these in the present invention. The sizes and shapes are not limited by the accompanying figures and the structures encompassed in the scope of the present invention are claimed.

1. Bases with mechanism for stand up tap pouch
Bases for positioning pouches with a mechanism for aiding the emptying, consisting of the base (1) and the mechanism (9) for aiding the emptying of the pouches and characterized in that the base (1) consists of a flat surface (2) on which the pouches (6) and (12) rest, a front side (3), a port (4) through which the taps (7) are passed and legs (5), wherein on the surface (2) of the base (1) there are ports (10) and (11) through which the bases (15) of the mechanism (9) for aiding the emptying are passed and mounted.

2. Bases for positioning pouches with a mechanism for aiding the emptying according to claim 1, consisting of the base (1) and the mechanism (9) for aiding the emptying of the pouches, wherein the mechanism for aiding the emptying of the individual pouches is characterized in that it is retractable and consists of a cylindrical part (13) adjacent on the pouches (12) and connected with the arms (14), wherein the arms (14) are forced by the action of the springs (18), so that the cylindrical part (13) presses the side of the pouches (12) forcing it to empty, wherein bases (15) are articulately connected to the arms (14), the bases (15) passing through the ports (10) and (11) where the mechanisms are stabilized on the bases (1).

3. Bases for positioning pouches with a mechanism for aiding the emptying according to claim 1, characterized in that they are also suitable for pouches covered with a paper housing, however the aiding mechanism is not exploited.

4. Bases for positioning pouches with a mechanism for aiding the emptying according to claim 1, consisting of the base (8) and the mechanism (9), characterized in that the base is manufactured from a wire mesh.

5. Bases for positioning pouches (30) with a mechanism for aiding the emptying according to claim 1, characterized in that for their support they have on the rear side a surface (31) configured vertical to the surface (2) supporting the pouches, which has holes (29) for suspending these on vertical surfaces.
